(19) United States
(12) Patent Application Publication
(10) Pub. No.: US 2011/0238320 A1
(43) Pub. Date: Sep. 29, 2011

(54) INTERACTION FORCE CHANGE PREDICTION APPARATUS AND INTERACTION FORCE CHANGE PREDICTION METHOD

(76) Inventor: Noriko Shimba, Nara (JP)

(21) Appl. No.: 13/075,560

(22) Filed: Mar. 30, 2011

Related U.S. Application Data
(63) Continuation of application No. PCT/JP2010/005066, filed on Aug. 16, 2010.

(30) Foreign Application Priority Data
Mar. 24, 2010 (JP) 2010-068976

(51) Int. Cl. G06F 19/00

(52) U.S. Cl. 702/19

(57) ABSTRACT

An interaction force change prediction apparatus includes: a pre-mutation combination data creation unit which creates pre-mutation combination data including a plurality of three-residue combinations, each combination having a pair of amino acid residues and one amino acid residue adjacent to one of the amino acid residues in the pair; a post-mutation combination data creation unit which creates post-mutation combination data including post-mutation three-residue combinations; an interaction score calculation unit which calculates a pre-mutation interaction score for the three-residue combinations included in the pre-mutation combination data and a post-mutation interaction score for the post-mutation three-residue combinations included in the post-mutation combination data, by reference to a three-residue combination table; and a predicted-value calculation unit which calculates a difference between the pre-mutation interaction score and the post-mutation interaction score.

### CROSS REFERENCE TO RELATED APPLICATION

This is a continuation application of PCT application No. PCT/JP2010/005066 filed on Aug. 16, 2010, designating the United States of America.

### BACKGROUND OF THE INVENTION

(1) Field of the Invention

The present invention relates to an interaction force change prediction apparatus which predicts a change in an interaction force between interacting proteins through bioinformatics data processing.

(2) Description of the Related Art

Various kinds of methods have been proposed for predicting an interaction between proteins.

Suppose as an example that a complex conformation showing three-dimensional structures of two interacting proteins is known and that a mutation is applied to one of the proteins based on this complex conformation. Then, an interaction change caused between these proteins as a result of the mutation is to be predicted. For such a case, there is a method of predicting changes to be caused in the complex conformation and in the free energy of binding as a result of residue substitution, according to a simulation algorithm based on physical chemistry such as molecular dynamics. This method is disclosed by, for example, Shaun M. Lippow et al., in “Computational design of antibody-affinity improvement beyond in vivo maturation”, Nature biotechnology, volume 25, number 10, 2007 (referred to as Non-Patent Reference 1 hereafter).

Moreover, in the case where only primary structures of two proteins are known, there is a method of predicting an interaction between the proteins by searching for a given pair of amino acid sequences corresponding to the proteins through a set of scored sequence pairs obtained by scoring, according to interactive properties, pairs of amino acid sequences each having a predetermined length. This method is disclosed by the following references, for example.

### Patent Reference 1: Japanese Patent No. 4320145

Non-Patent Reference 2: Kentaro Shimizu et al., “Development of a protein-protein interaction change prediction system having a high-precision docking function”, Ministry of Education, Culture, Sports, Science, and Technology of Japan, Annual report on priority area “Genome”, Area 1, Life system information, 2007
Non-Patent Reference 3: Kentaro Shimizu et al., “Comprehensive study ranging from neural network estimation of protein-protein interaction to atomic-level bonding prediction”, Ministry of Education, Culture, Sports, Science, and Technology of Japan, Annual report on priority area “Genome”, Area 1, Life system information, 2008

FIG. 19 is a block diagram showing a functional configuration of a conventional protein-protein interaction force prediction apparatus disclosed in Patent Reference 1. As shown in FIG. 19, a protein-protein interaction force prediction apparatus 1 includes: a scored sequence-pair generation unit 30 having a sequence pair generation unit 10 and a sequence pair evaluation unit 20; an interaction prediction unit 40; an interaction candidate selection unit 50; and a mutant designing unit 60. The scored sequence-pair generation unit 30 generates a set of scored sequence pairs which is a group of pairs of amino acid sequences of proteins, each pair given a score regarding the interaction between the amino acid sequences. The interaction prediction unit 40 predicts an interaction between two proteins, on the basis of the generated set of scored sequence pairs. This set of scored sequence pairs include: a pair of amino acid subsequences each of which has a predetermined length and is a part of an amino acid sequence of a protein; and a score.

### SUMMARY OF THE INVENTION

However, the simulation algorithm based on the physical chemistry as disclosed in Non-Patent Reference 1 has a problem that a dynamic computational environment, for example, is necessary for predicting a post-mutation complex conformation and calculating a post-mutation change in the free energy of binding. That is to say, computational resources need to be installed on a large scale. Also, since the computational load for such processing is high, a long period of time is required to perform the simulation while completely covering patterns for each mutation.

Moreover, the protein-protein interaction force prediction apparatus 1 predicts the interaction between the two proteins using, as search information for making the prediction, the aforementioned set of scored sequence pairs which includes a pair of amino acid subsequences each having a predetermined length and a score. Suppose here that this protein-protein interaction force prediction apparatus 1 performs the processing, using a combination of three amino acids as the amino acid subsequence having the predetermined length. Note that Non Patent References 2 and 3 disclose that combinations of three amino acids show the best result. Even in this case, the number of data pieces included in the set of scored sequence pairs is equal to 20 (the number of amino acid types) raised to the sixth power, i.e., 32,000,000 pieces. Therefore, memory used for generating this large number of data pieces and for searching through these data pieces is required, thereby leading to a problem of high computational load.

The present invention is conceived in view of the aforementioned problem, and has an object to provide an interaction force change prediction apparatus and an interaction force change prediction method capable of predicting, even with less computational resources, an interaction force change caused between two interacting proteins as a result of a mutation applied to one of the two interacting proteins at an interacting site based on a known complex conformation.

In order to achieve the aforementioned object, the interaction force change prediction apparatus according to an aspect of the present invention is an interaction force change prediction apparatus which predicts an interaction force change to be caused between two interacting proteins as a result of a mutation applied to at least one of the two interacting proteins, the interaction force change prediction apparatus including: a pre-mutation combination data creation unit which creates pre-mutation combination data including a plurality of three-residue combinations that are obtained by reference to complex conformation information indicating each position of atoms included in the two interacting proteins, the three-residue combinations each including (i) a pair of amino acid residues which are included in the two interacting proteins, respectively, and which are closely positioned at a predetermined distance from each other at a binding site of the two interacting proteins and (ii) one amino acid residue which is adjacent, in an amino acid sequence, to one of the amino acid residues in the pair, in an N-terminal or C-terminal direction; a post-mutation combination data creation unit which creates post-mutation combination data by reference to mutation information indicating a position of a pre-mutation amino acid residue of the protein to which the mutation is to be applied and a type of a resultant post-mutation amino acid residue, the post-mutation combination data including a post-mutation three-residue combination in which a type of the pre-mutation amino acid residue has been substituted with the type of the post-mutation amino acid residue for each of the three-residue combinations included in the pre-mutation combination data; an interaction score calculation unit which calculates a pre-mutation interaction score and a post-mutation interaction score by reference to a three-residue combination table which shows a three-character string representing types of three arbitrary amino acid residues in association with a combination score indicating an interaction force produced when the three arbitrary amino acid residues represented by the three-character string form the three-residue combination at the binding site of the two interacting proteins, the pre-mutation interaction score indicating a mean value of the combination scores of the three-residue combinations included in the pre-mutation combination data and the post-mutation interaction score indicating a mean value of the combination scores of the post-mutation three-residue combinations included in the post-mutation combination data; and a predicted-value calculation unit which calculates a difference between the pre-mutation interaction score and the post-mutation interaction score, as a predicted value for predicting the interaction force change to be caused between the two interacting proteins as a result of the mutation indicated by the mutation information.

With this, the pre- and post-mutation interaction forces are calculated for the pre- and post-mutation combination data, respectively, by reference to the three-residue combination table showing a character string representing a three-residue combination and an interaction force. Since the number of amino acid types is 20, the number of character strings is 8,000 which is calculated by 20*20*20. In other words, the three-residue combination table includes 8,000 pairs of a three-residue-combination character string and an interaction force. This means that when the pre- or post-mutation interaction force is calculated, a combination character string matching the character string representing the corresponding three-residue combination is simply searched through the 8,000 data pieces at the maximum. As compared to the conventional method by which 32,000,000 data pieces are used, an interaction force change resulting from the mutation can be predicted at high speed even with less computational resources.

It should be noted that the present invention can be implemented not only as an interaction force change prediction apparatus including the characteristic processing units as described above, but also as an interaction force change prediction method having, as steps, the characteristic processing units included in the interaction force change prediction apparatus. Also, the present invention can be implemented as a program causing a computer to execute the characteristic steps including in the interaction force change prediction method. It should be obvious that such a program can be distributed via a computer-readable nonvolatile recording medium such as a Compact Disc Read Only Memory (CD-ROM) or via a communication network such as the Internet.

The present invention can predict, even with less computational resources, an interaction force change to be caused between two interacting proteins as a result of a mutation applied to one of the two proteins at an interacting site based on a known complex conformation.

### FURTHER INFORMATION ABOUT TECHNICAL BACKGROUND TO THIS APPLICATION

The disclosure of Japanese Patent Application No. 2010-068976 filed on Mar. 24, 2010 including specification, drawings and claims is incorporated herein by reference in its entirety.

The disclosure of PCT application No. PCT/JP2010/005066 filed on Aug. 16, 2010, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing an entire configuration of an interaction force change prediction apparatus in an embodiment according to the present invention;

FIG. 2 is a flowchart showing a process performed by a table creation unit;

FIG. 3 is a flowchart showing a process performed by a pre-mutation combination data creation unit;

FIG. 4 is a schematic diagram showing amino acid residues at a binding site of proteins;

FIG. 5 is a diagram showing an example of amino acid residues at the binding site of the proteins;

FIG. 6 is a diagram showing an example of three-residue combination data;

FIG. 7 is a flowchart showing a detailed process of creating a three-residue combination table;

FIG. 8 is a diagram showing an example of the three-residue combination table;

FIG. 9 is a flowchart showing a process executed by a change prediction unit;

FIG. 10 is a diagram showing an example of amino acid residues at a binding site of proteins;

FIG. 11 is a diagram showing an example of post-mutation amino acid residues at the binding site of the proteins;

FIG. 12 is a diagram showing an example of three-residue combination data generated using received complex conformation information;

FIG. 13 is a diagram showing an example of three-residue combination data generated on the basis of post-mutation proteins;

FIG. 14 is a flowchart showing a process performed by an interaction score calculation unit;

FIG. 15 is a diagram showing an example of a residue pair table;

FIG. 16 is a diagram showing an external view of an interaction force change prediction apparatus;

FIG. 17 is a block diagram showing a hardware configuration of the interaction force change prediction apparatus;

FIG. 18 is a diagram showing a correlation between a predicted value and an experimental value; and.

FIG. 19 is a block diagram showing a functional configuration of a conventional protein-protein interaction force prediction apparatus.

### DESCRIPTION OF THE PREFERRED EMBODIMENT

The following is a description of an embodiment according to the present invention, with reference to the drawings.

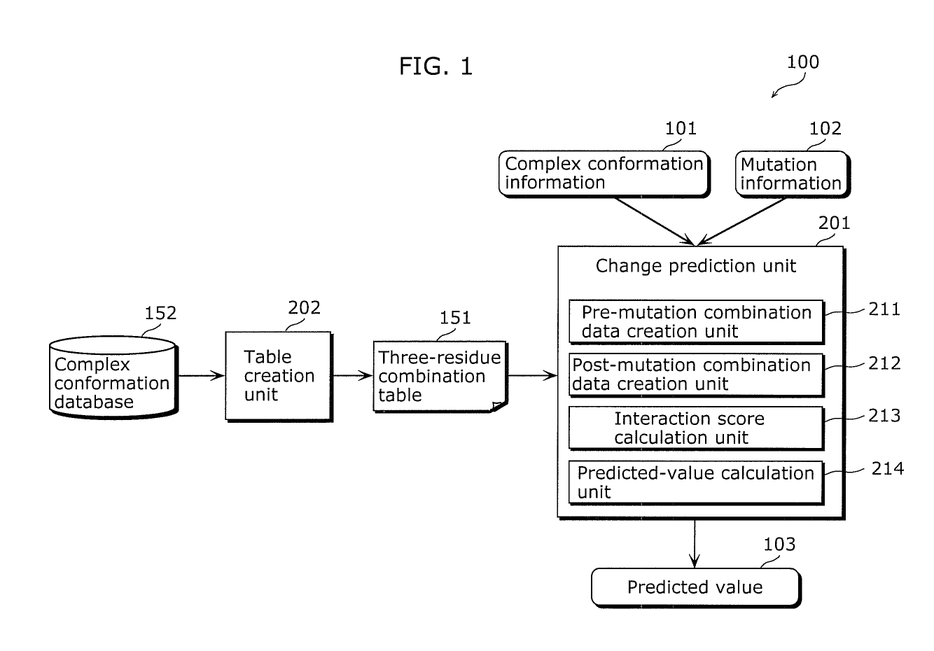

FIG. 1 is a diagram showing an entire configuration of an interaction force change prediction apparatus in an embodiment according to the present invention.

An interaction force change prediction apparatus 100 is an apparatus which predicts an interaction force change caused between two interacting proteins as a result of a mutation. The interaction force change prediction apparatus 100 includes a complex conformation database 152, a table creation unit 202, and a change prediction unit 201.

The complex conformation database 152 is a database of information on a complex three-dimensional structure showing a binding state of two interacting proteins. Hereafter, this information is referred to as the “complex conformation information”. The complex conformation database 152 is configured with a hard disk drive (HDD), a memory, or the like.

The table creation unit 202 generates a three-residue combination table 151 from the complex conformation information stored in the complex conformation database 152. The three-residue combination table 151 is a data table, which shows a score as an interaction force for each combination of three amino acid residues. Here, this combination of three residues is made up of: a pair of two amino acid residues which are included in the two interacting proteins, respectively, and which are closely positioned at a predetermined distance from each other at a binding site of the two proteins; and one amino acid residue which is adjacent, in an amino acid sequence, to one of the amino acid residues in the pair, in the N-terminal or C-terminal direction.

The change prediction unit 201 predicts an interaction force change to be caused between the two interacting proteins as a result of a mutation, on the basis of complex conformation information 101, mutation information 102, and the three-residue combination table 151. As a prediction result, the change prediction unit 201 outputs an interaction-force predicted value 103. In the following description, the interaction-force predicted value 103 is simply referred to as the predicted value 103. Here, the complex conformation information 101 indicates three-dimensional structures of the two interacting proteins before the mutation. To be more specific, the complex conformation information 101 indicates each position of atoms included in the two interacting proteins. In the present specification of the present invention, when “before the mutation” and “after the mutation” are referred, these expressions may be represented as “pre-mutation” and “post-mutation”, respectively. The mutation information 102 indicates a position of a pre-mutation amino acid residue included in the protein to which the mutation is to be applied, and also indicates a type of a resultant post-mutation amino acid residue. The predicted value 103 is used for predicting an interaction force change to be caused between the two proteins as a result of the mutation indicated by the mutation information 102. The change prediction unit 201 has a pre-mutation combination data creation unit 211, a post-mutation combination data creation unit 212, an interaction score calculation unit 213, and a predicted-value calculation unit 214. These processing units included in the change prediction unit 201 are described in detail later.

Next, a process executed by the table creation unit 202 is explained.

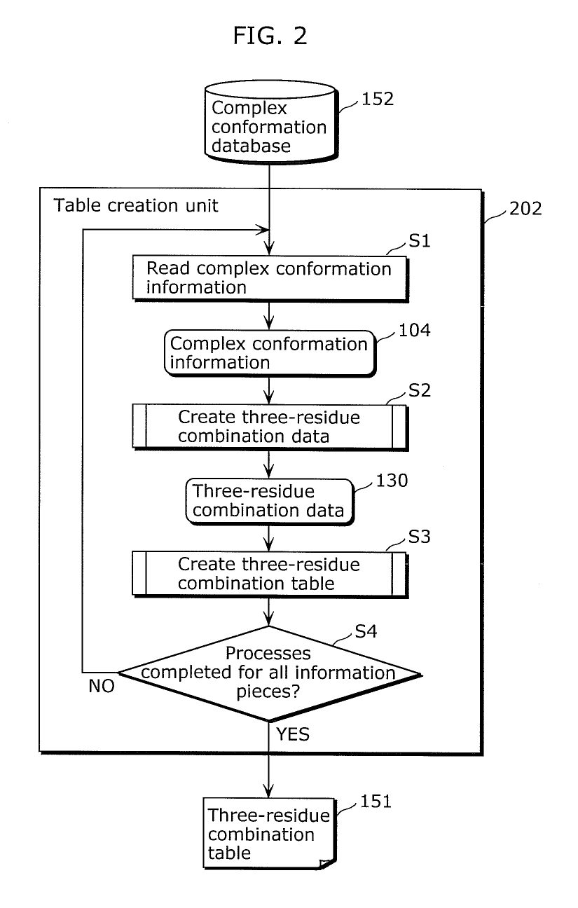

FIG. 2 is a flowchart showing the process performed by the table creation unit 202.

The table creation unit 202 reads one piece of complex conformation information 104 from the complex conformation database 152 (S1).

The pre-mutation combination data creation unit 211 creates three-residue combination data 130 from the read complex conformation information 104 (S2). The three-residue combination data 130 is a data table which shows a score as an interaction force for each three-residue combination and which is temporarily generated when the three-residue combination table 151 is to be generated.

The table creation unit 202 creates the three-residue combination table 151 summarizing the three-residue combination data 130 (S3). Note that the process of creating the three-residue combination table 151 is described later.

The table creation unit 202 determines whether or not the processes from S1 to S3 have been executed for all the complex conformation information pieces included in the complex conformation database 152 (S4).

When there is complex conformation information for which the processes from S1 to S3 have not been completed (NO in S4), the table creation unit 202 executes the processes from S1 to S3 for this complex conformation information.

When determining that the processes from S1 to S3 have been completed for all the complex conformation information pieces (YES in S4), the table creation unit 202 outputs the three-residue combination table 151 and terminates the process.

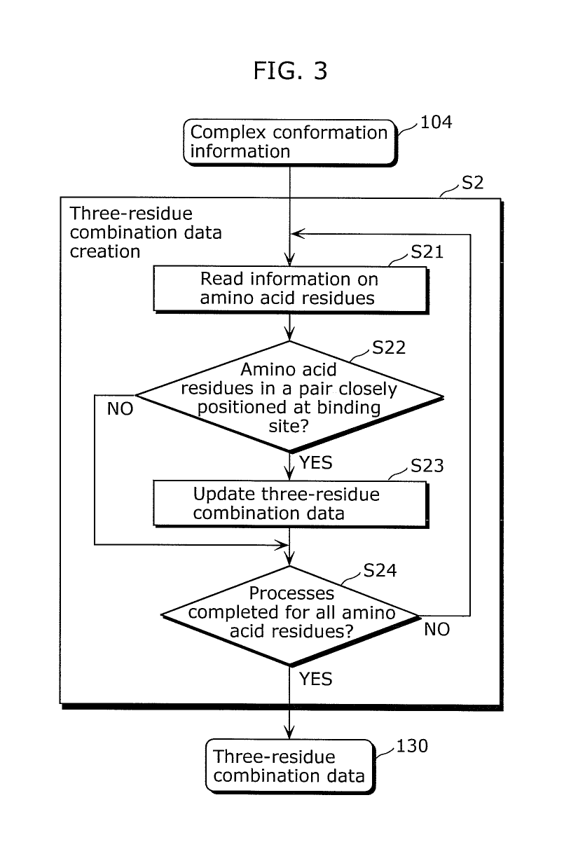

Next, the process of creating the three-residue combination data 130 performed in S2 of FIG. 2 is described in detail. FIG. 3 is a flowchart showing the details of the three-residue combination data creation process.

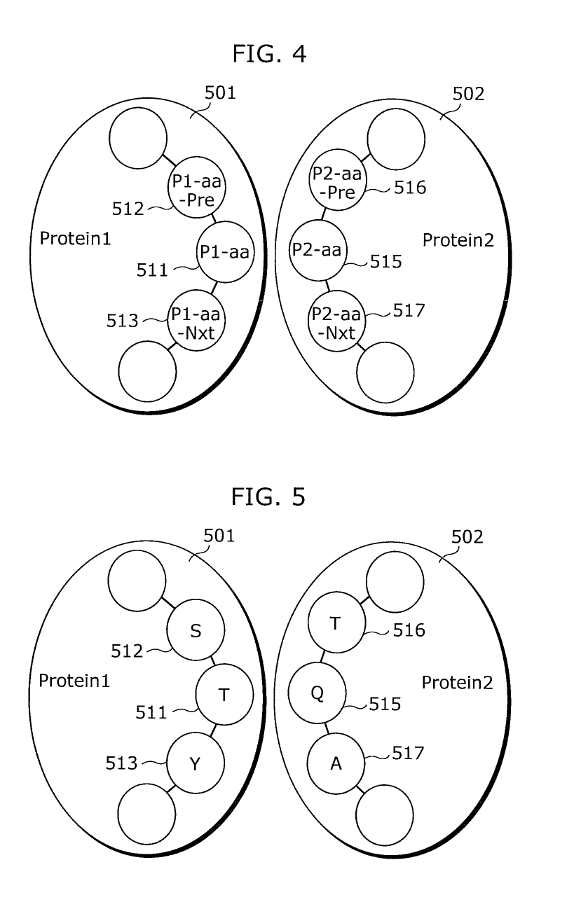

The table creation unit 202 reads three-dimensional structure information on amino acid residues of the two interacting proteins, from the complex conformation information 104 (S21). FIG. 4 is a schematic diagram showing the two interacting proteins. An amino acid residue 511 of a protein 501 and an amino acid residue 515 of a protein 502 are closely positioned at a binding site of these two proteins 501 and 502. In an amino acid sequence including the amino acid residue 511, amino acid residues 512 and 513 are adjacent to the amino acid residue 511 in the N-terminal and C-terminal directions, respectively. Similarly, in an amino acid sequence including the amino acid residue 515, amino acid residues 516 and 517 are adjacent to the amino acid residue 515 in the N-terminal and C-terminal directions, respectively. The three-dimensional structure information read in S21 includes: sequences of the amino acid residues of the proteins 501 and 502; and three-dimensional coordinates of each atom included in the amino acid residues.

On the basis of the amino acid residues of the two proteins shown by the read three-dimensional structure information, the table creation unit 202 determines whether or not the amino acid residues in a pair are closely positioned at the binding site (S22). To be more specific, when a pair of amino acid residues between which a distance between Cα atoms is equal to or shorter than 12*10⁻¹⁰ m is present in the proteins, the table creation unit 202 determines that the amino acid residues in this pair are closely positioned at the binding site of the proteins. Hereafter, the distance between Cα atoms is referred to as the Cα-Cα distance. On the other hand, when there is no such a pair of amino acid residues, the table creation unit 202 determines that the amino acid residues of the two proteins are not closely positioned at the binding site. FIG. 5 is a diagram showing the amino acid residues at the binding site of the two interacting proteins. In the case of the example shown in FIG. 5, among the amino acid residues included in the protein 501, the amino acid residue 511 which comes in contact with the protein 502 is threonine (indicated as “T”). Also, among the amino acid residues included in the protein 502, the amino acid residue 515 which comes in contact with the amino acid residue 511 of the protein 501 is glutamine (indicated as “Q”). Moreover, the amino acid residue 512 which is adjacent to the amino acid residue 511 in the amino acid sequence of the protein 501 in the N-terminal direction is serine (indicated as “S”). The amino acid residue 513 which is adjacent to the amino acid residue 511 in the amino acid sequence of the protein 501 in the C-terminal direction is tyrosine (indicated as “Y”). The amino acid residue 516 which is adjacent to the amino acid residue 515 in the amino acid sequence of the protein 502 in the N-terminal direction is threonine (indicated as “T”). The amino acid residue 517 which is adjacent to the amino acid residue 515 in the amino acid sequence of the protein 502 in the C-terminal direction is alanine (indicated as “A”). Here, the Cα-Cα distance between the amino acid residues 511 and 515 is 9.60*10⁻¹⁰ m, which is shorter than 12*10⁻¹⁰ m. On account of this, it is determined that the amino acid residues 511 and 515 are closely positioned.

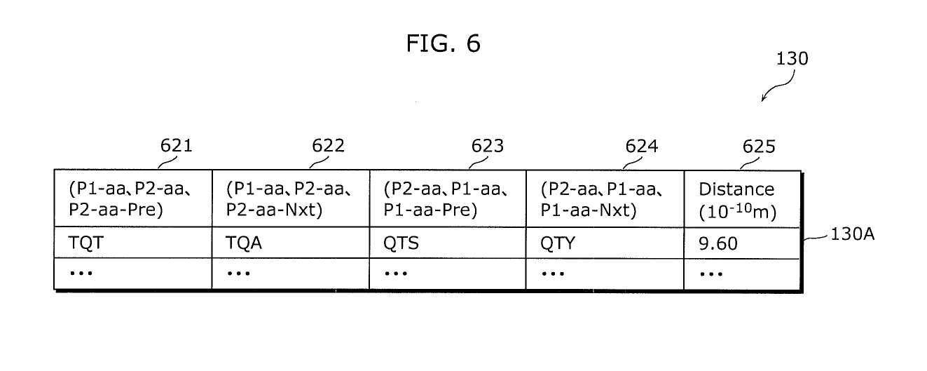

When determining that the amino acid residues in the pair are closely positioned at the binding site (YES in S22), the table creation unit 202 updates the three-residue combination data 130 (S23). FIG. 6 is a diagram showing an example of the three-residue combination data 130. As shown, the three-residue combination data 130 has five columns. In a column 621, a combination of the three amino acid residues 511, 515, and 516 is represented by a character string made up of three consecutive characters. In a column 622, a combination of the three amino acid residues 511, 515, and 517 is represented by a character string made up of three consecutive characters. In a column 623, a combination of the three amino acid residues 511, 515, and 512 is represented by a character string made up of three consecutive characters. In a column 624, a combination of the three amino acid residues 511, 515, and 513 is represented by a character string made up of three consecutive characters. In a column 625, the Cα-Cα distance between the amino acid residues 511 and 515 is shown. The table creation unit 202 updates the three-residue combination data 130 by adding a row to the three-residue combination data 130. More specifically, in the case of the example shown in FIG. 5, the character strings “TQT”, “TQA”, QTS″, and “QTY” are added into the columns 621, 622, 623, and 624, respectively, as shown in FIG. 6. For example, the character string “TQA” added into the column 622 indicates the combination of the amino acid residues 511, 515, and 517 which are represented by “T”, “Q”, and “A”, respectively. Also, “9.60” is added in the column 625 as the Cα-Cα distance between the amino acid residues 511 and 515 which are represented by “T” and “Q”, respectively.

The table creation unit 202 determines whether or not both the determination process (S22) to determine whether the amino acid residues are closely positioned and the update process (S23) to update the three-residue combination data 130 have been completed for all the amino acid residues included in the complex conformation information 104 (S24). When determining that there is an amino acid residue for which the above processes have not been completed (NO in S24), the table creation unit 202 reads this amino acid residue from the complex conformation information 104 (S21), and then executes the processes of S22 and S23. When determining that the above processes have been completed for all the amino acid residues (YES in S24), the table creation unit 202 terminates the process here.

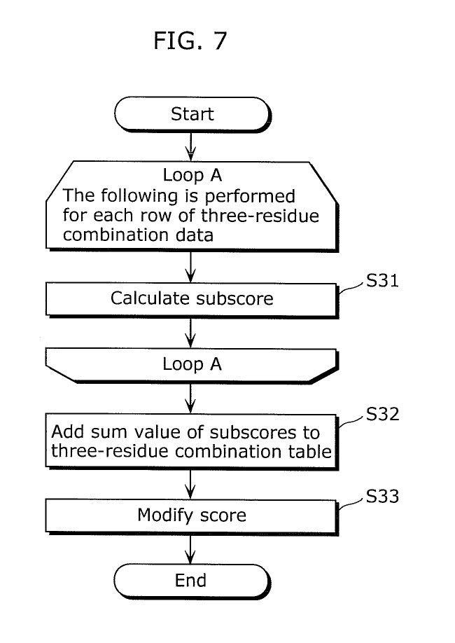

Next, the process of creating the three-residue combination table 151 performed in S3 of FIG. 2 is described in detail. FIG. 7 is a flowchart showing the details of the three-residue combination table creation process performed in S3 of FIG. 2.

By reference to the three-residue combination data 130, the table creation unit 202 calculates a subscore based on the Cα-Cα distance for each of the combinations of three residues included in the currently-focused row in the three-residue combination data 130 (S31). For example, in the case of the three-residue combination data 130 shown in FIG. 6, the table creation unit 202 calculates the subscore for each of the four combinations (which are: TQT, TQA, QTS, and QTY) shown in a row 130A according to Equation 1 described below. To be more specific, when the Cα-Cα distance is equal to or shorter than 6*10⁻¹⁰ m, the subscore is calculated as 1. On the other hand, when the Cα-Cα distance is longer than 6*10⁻¹⁰ m, the subscore is calculated as (12−Cα-Cα distance)/6. Here, the Cα-Cα distance of each of the four combinations shown in the row 130A is 9.60*10⁻¹⁰ m. Thus, the subscore is calculated as 0.4=(12-9.60)/6. It should be noted that the Cα-Cα distance entered in the three-residue combination data 130 is 12*10⁻¹⁰ m or shorter. Therefore, the subscore takes on values from 0 to 1.

$$Subscore = \{ \begin{matrix}1 ( when Ca - Ca distance \leq 6 * {10}^{- 10} m ) \\ \begin{matrix}( 12 - Ca - Ca distance ) / \\ 6 ( when Ca - Ca distance > 6 * {10}^{- 10} m )\end{matrix}\end{matrix} \qquad Equation 1$$

As shown in Table 1 below, each subscore of the four combinations shown in the row 130A is calculated as 0.4.

TABLE 1
Subscores of Three-Residue Combinations in Row 130A

| Three-residue | |
|---|---|
| Combination | Subscore |
| TQT | 0.4 |
| TQA | 0.4 |
| QTS | 0.4 |
| QTY | 0.4 |

The table creation unit 202 performs this subscore calculation process (S31) for each of the rows included in the three-residue combination data 130. This repeated process is also referred to as a loop A.

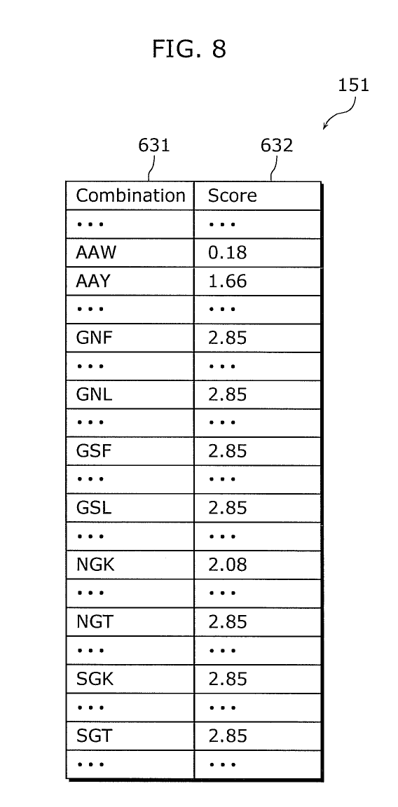

Following this, the table creation unit 202 calculates a sum for each kind of combination obtained in the loop A, and then adds this sum value as a score to the three-residue combination table 151 (S32). FIG. 8 is a diagram showing an example of the three-residue combination table 151. The three-residue combination table 151 has two columns. In a column 631, a combination of three amino acid residues is represented by a character string made up of three consecutive characters. This character string is similar to that shown in each of the columns 621 to 624 in the three-residue combination data 130 shown in FIG. 6. In a column 632, a score of the three-residue combination shown in the column 631 is shown. For example, a score of a three-residue combination “AAW” is calculated as 0.18 in S32. Here, since the number of amino acid types is 20, the number of three-residue combinations is 8,000 which is calculated by 20*20*20. In other words, the three-residue combination table 151 includes 8,000 combinations of three residues.

Then, the table creation unit 202 calculates a mean value of all the scores shown in the column 632 of the three-residue combination table 151, and then modifies a score value which is larger than the calculated mean value to the calculated mean value (S33). For example, when the mean value is calculated as 2.85, a score value larger than 2.85 is modified to 2.85. FIG. 8 shows the three-residue combination table 151 obtained after the score modification. As shown in FIG. 8, scores of the three-residue combinations “GNF” and “GNL”, for instance, have been modified to 2.85.

Through the processes as described, the table creation unit 202 creates the three-residue combination table 151.

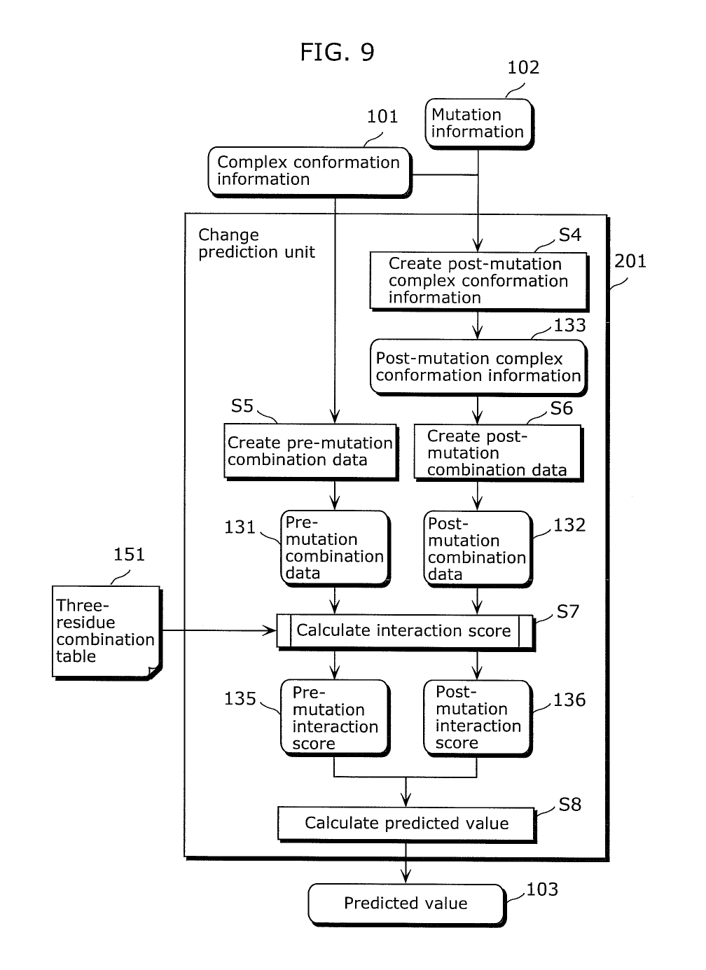

Next, the process performed by the change prediction unit 201 to predict a change in the interaction force using the created three-residue combination table 151 is described in detail. FIG. 9 is a flowchart showing the process performed by the change prediction unit 201.

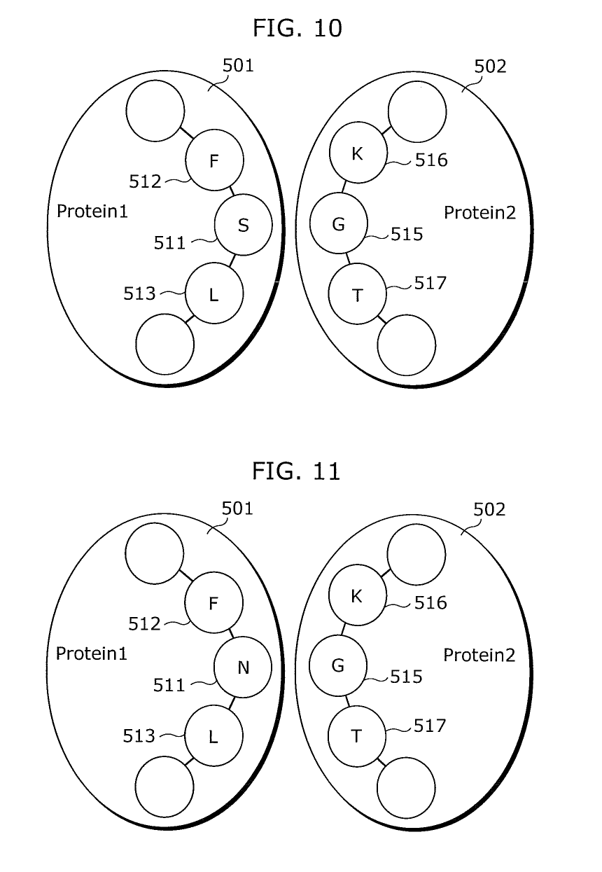

The change prediction unit 201 receives the complex conformation information 101. From the complex conformation information 101, information on the amino acid residues at the binding site of the proteins as shown in FIG. 10 can be obtained. To be more specific, among the amino acid residues included in the protein 501, the amino acid residue 511 which comes in contact with the protein 502 is serine (indicated as “S”). Also, among the amino acid residues included in the protein 502, the amino acid residue 515 which comes in contact with the amino acid residue 511 of the protein 501 is glycine (indicated as “G”). Moreover, the amino acid residue 512 which is adjacent to the amino acid residue 511 in the amino acid sequence of the protein 501 in the N-terminal direction is phenylalanine (indicated as “F”). The amino acid residue 513 which is adjacent to the amino acid residue 511 in the amino acid sequence of the protein 501 in the C-terminal direction is leucine (indicated as “L”). The amino acid residue 516 which is adjacent to the amino acid residue 515 in the amino acid sequence of the protein 502 in the N-terminal directions is lysine (indicated as “K”). The amino acid residue 517 which is adjacent to the amino acid residue 515 in the amino acid sequence of the protein 502 in the C-terminal directions is threonine (indicated as “T”).

On the basis of the complex conformation information 101 and the mutation information 102, the change prediction unit 201 creates post-mutation complex conformation information 133 by forming three-dimensional structures of the proteins to be obtained after the mutation indicated by the mutation information 102 is applied to the protein shown by the complex conformation information 101 (S4). As one example, suppose that the mutation information 102 indicates information on a mutation whereby the amino acid residue 511 is changed to asparagine (referred to as “N”). To be more specific, out of the amino acid residues at the binding site of the proteins 501 and 502 shown in FIG. 10, the amino acid residue 511 is changed from S to N. As a result of this, post-mutation information of the amino acid residues at the binding site of the proteins 501 and 502 is created as the post-mutation complex conformation information 133 as shown in FIG. 11.

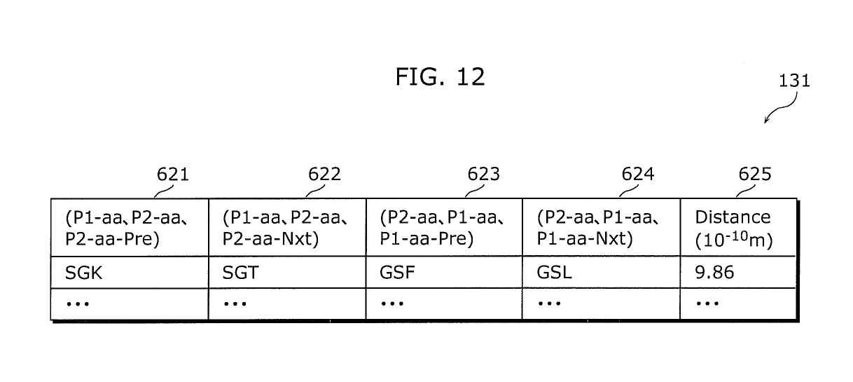

The pre-mutation combination data creation unit 211 creates pre-mutation three-residue combination data 131 from the complex conformation information 101 (S5). The pre-mutation three-residue combination data 131 is simply referred to as the pre-mutation combination data 131 hereafter. The process of creating the pre-mutation combination data 131 performed in S5 is identical to the process performed by the table creation unit 202 to create the three-residue combination data 130 in S2 of FIG. 2. Therefore, the detailed explanation of this process is not repeated here. Through this process in S5, the pre-mutation combination data 131 as shown in FIG. 12 can be created on the basis of the complex conformation information 101 indicating the amino acid residues at the binding site of the proteins 501 and 502 as shown in FIG. 10. Columns in the pre-mutation combination data 131 are the same as those in the three-residue combination data 130 shown in FIG. 6. Therefore, the detailed explanation of the columns is not repeated here. As shown in FIG. 12, the character strings representing the three-residue combinations at the binding site of the proteins 501 and 502 are “SGK”, “SGT”, “GSF”, and “GSL”. Here, the Cα-Cα distance between the amino acid residues 511 and 515, which are represented by S and G respectively, is 9.86*10⁻¹⁰ m.

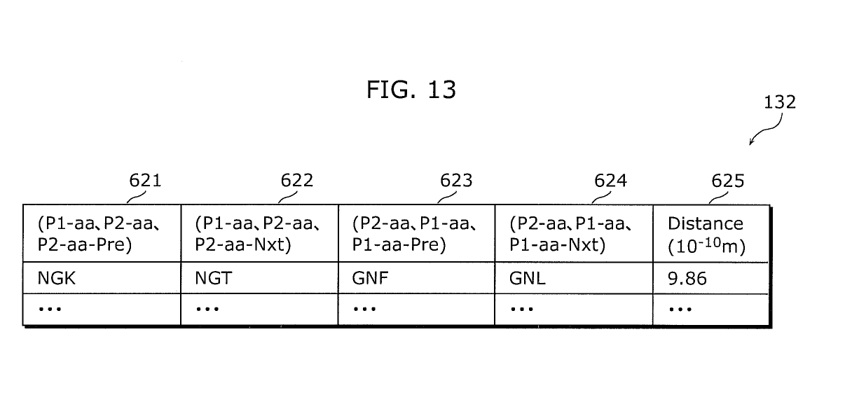

Moreover, the post-mutation combination data creation unit 212 creates post-mutation three-residue combination data 132 from the post-mutation complex conformation information 133 (S6). In the following description, the post-mutation three-residue combination data 132 is simply referred to as the post-mutation combination data 132. The process of creating the post-mutation combination data 132 performed in S6 is identical to the process performed by the table creation unit 202 to create the three-residue combination data 130 in S2 of FIG. 2. Therefore, the detailed explanation of this process is not repeated here. Through this process in S6, the post-mutation combination data 132 as shown in FIG. 13 can be created on the basis of the post-mutation complex conformation information 133 indicating the amino acid residues at the binding site of the proteins 501 and 502 as shown in FIG. 11. Columns in the post-mutation combination data 132 are the same as those in the three-residue combination data 130 shown in FIG. 6. Therefore, the detailed explanation of the columns is not repeated here. As shown in FIG. 13, the character strings representing the three-residue combinations at the binding site of the proteins 501 and 502 are “NGK”, “NGT”, “GNF”, and “GNL”. Here, the Cα-Cα distance between the amino acid residues 511 and 515, which are represented by N and G respectively, is 9.86*10⁻¹⁰ m. Here, suppose that coordinates of the Cα atom of each amino acid residue do not change. On account of this, the Cα-Cα distance in the column 625 of the post-mutation combination data 132 in FIG. 13 shows the same value as that of the pre-mutation combination data 131 in FIG. 12.

Next, on the basis of the pre-mutation combination data 131 and the three-residue combination table 151, the interaction score calculation unit 213 calculates a pre-mutation interaction score 135 which indicates an interaction force between the proteins shown by the complex conformation information 101. Moreover, on the basis of the post-mutation combination data 132 and the three-residue combination table 151, the interaction score calculation unit 213 calculates a post-mutation interaction score 136 which indicates an interaction force between the proteins shown by the post-mutation complex conformation information 133 (S7). The process of calculating these interaction scores in S7 is described in detail later.

The predicted-value calculation unit 214 calculates the predicted value 103 which indicates an interaction force change caused between the two proteins as a result of the mutation, by subtracting the pre-mutation interaction score 135 from the post-mutation interaction score 136 (S8).

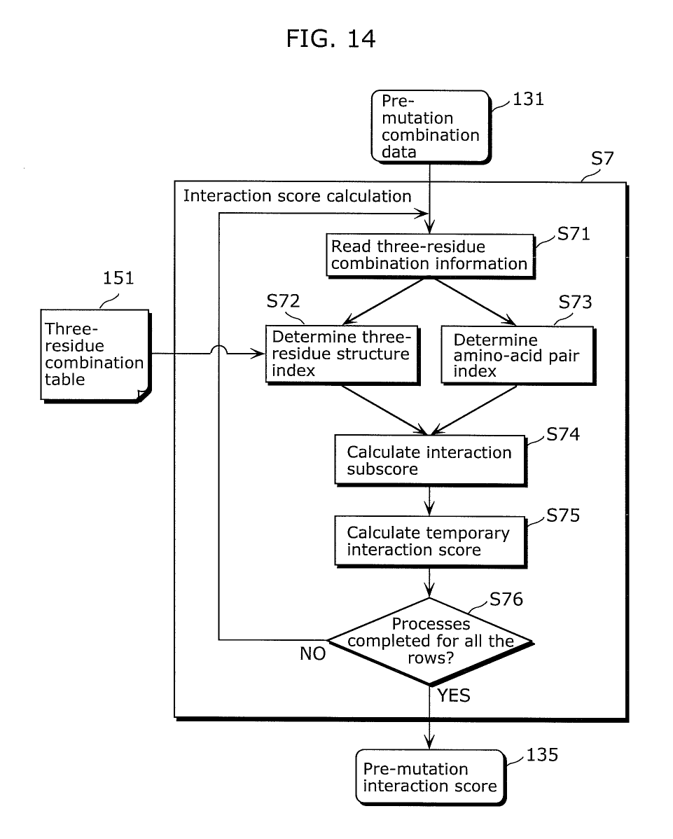

Next, the process of calculating the interaction score in S7 is described in detail. FIG. 14 is a flowchart showing the details of the interaction score calculation process performed in S7.

First, the interaction score calculation unit 213 reads one row of the character strings each of which represents a combination of amino acid residues by three consecutive characters, from the pre-mutation combination data 131 (S71). To be more specific, from the pre-mutation combination data 131 shown in FIG. 12, the interaction score calculation unit 213 reads one row which includes the three-character strings “SGK”, “SGT”, “GSF”, and “GSL” shown in the columns 621, 622, 623, and 624, respectively.

The interaction score calculation unit 213 searches through the three-residue combination table 151 for the scores of the three-residue combinations represented by the three-character strings read in S71, and then calculates the mean value of these searched scores as a three-residue structure index (S72). To be more specific, the interaction score calculation unit 213 searches through the columns 631 in the three-residue combination table 151 for the character strings matching the three-character strings read in S71, and calculates the mean value of the scores shown in the corresponding columns 632. For example, in the case where the three-character strings “SGK”, “SGT”, “GSF”, and “GSL” are read as described above, the interaction score calculation unit 213 extracts the four scores “2.85” corresponding to these character strings “SGK”, “SGT”, “GSF”, and “GSL” from the three-residue combination table 151 shown in FIG. 8. Then, the interaction score calculation unit 213 calculates a mean value of these four scores as “2.85”.

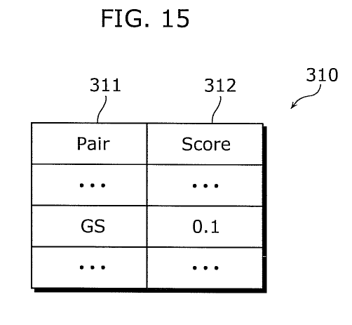

Also, the interaction score calculation unit 213 determines an amino-acid pair index which indicates an interaction force between the amino acid residues 511 and 515 in the pair at the binding site of the proteins 501 and 502 shown in the complex conformation information 101 (S73). More specifically, the first two characters of the three-character string read in S71 represent this pair of amino acid residues. For example, in the aforementioned case, “SG” represents the pair of amino acid residues. The interaction score calculation unit 213 determines the amino-acid pair index indicating the interaction force between the amino acid residues in the pair, by reference to a residue pair table 310 as shown in FIG. 15. The residue pair table 310 has two columns. In a column 311, the pair of amino acid residues is represented by a character string made up of two consecutive characters. In a column 312, an amino-acid pair index of the pair shown in the column 311 is shown. Note that since the number of amino acid types is 20, the number of pairs of amino acid residues is 400 which is calculated by 20*20. In other words, the residue pair table 310 includes 400 pairs of amino acid residues. Note that, however, the pairs of amino acid residues which are simply different in permutation of characters, such as “GS” and “SG”, have the same value as the amino-acid pair index. On this account, it is possible to reduce the number of amino-acid-residue pairs included in the residue pair table 310 to 200. Examples of the amino-acid pair index are disclosed by Betancourt M R et al., in “Pair potentials for protein folding: Choice of reference states and sensitivity of predicted native states to variations in the interaction schemes”, PROTEIN SCIENCE, volume 8, Issue 2, 1999 (referred to as Non-Patent Reference 4). Therefore, the detailed description is omitted here. From the residue pair table 310, the amino-acid pair index corresponding to the pair of amino acid residues represented by “GS” is determined to be 0.1.

The interaction score calculation unit 213 calculates an interaction subscore by multiplying the three-residue structure index determined in S72 and the amino-acid pair index determined in S73 by different predetermined coefficients, respectively, and then performing addition or subtraction on the multiplication results (S74). To be more specific, in order to process the three-residue structure index and the amino-acid pair index with the same weight, the interaction score calculation unit 213 calculates the interaction subscore according to Equation 2 as follows based on the value ranges of the three-residue structure index and amino-acid pair index. More specifically, the value range of three-residue structure index is 0 to 2.85, and the value range of the amino-acid pair index is 0 to 2.

Interaction subscore=amino-acid pair index*2.85−three-residue structure index*2 Equation 2

Subtraction is performed here because the three-residue structure index and the amino-acid pair index are opposite in polarity. That is, when the value of the amino-acid pair index is larger, this means that the two proteins repel each other more. When the value of the amino-acid pair index is smaller, this means that the two proteins attract each other more. On the other hand, when the value of the three-residue structure index is larger, this means that the two proteins attract each other more. When the value of the three-residue structure index is smaller, this means that the two proteins repel each other more. It should be noted that the coefficients by which these indexes are multiplied respectively may be changed.

In the aforementioned case, the three-residue structure index is 2.85 and the amino-acid pair index is 0.1. Thus, the interaction subscore is calculated as −5.415.

The interaction score calculation unit 213 calculates a mean value of the calculated interaction subscores, as a temporary interaction score (S75).

The interaction score calculation unit 213 determines whether or not the processes from S71 to S75 have been completed for all the rows included in the pre-mutation combination data 131 (S76). When there is a row for which the processes have not been completed (NO in S76), the interaction score calculation unit 213 repeats the processes from S71. When determining that the processes have been completed for all the rows (YES in S76), the interaction score calculation unit 213 outputs the current temporary interaction score, as the pre-mutation interaction score 135.

The interaction score calculation unit 213 performs the processes shown in FIG. 14 on the post-mutation combination data 132 as well, and calculates the post-mutation interaction score 136. That is, the interaction score calculation unit 213 performs the processes shown in FIG. 14 on the post-mutation combination data 132 in place of the pre-mutation combination data 131. As a result, the post-mutation interaction score 136 is calculated in place of the pre-mutation interaction score 135.

Suppose here that, through the processes described thus far, the pre-mutation interaction score 135 is calculated as −5.415 and the post-mutation interaction score 136 is calculated as −5.035. From these results, the predicted value 103 is calculated as 0.38 (=−5.035−(−5.415)) in the aforementioned process of calculating the predicted value 103 in S8.

It should be noted that the interaction force change prediction apparatus 100 can be implemented as a computer.

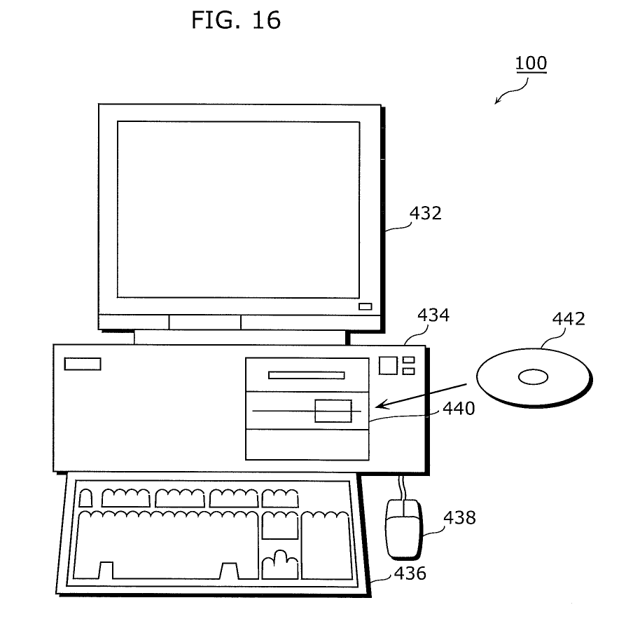

FIG. 16 is a diagram showing an external view of the interaction force change prediction apparatus 100. The interaction force change prediction apparatus 100 includes: a computer 434; a keyboard 436 and a mouse 438 which provide instructions to the computer 434; a display 432 which displays information such as calculation results received from the computer 434; a CD-ROM device 440 which reads a program to be executed by the computer 434; and a communication modem which is not illustrated.

The program for predicting the interaction force change is stored in a CD-ROM 442 which is a non-transitory computer-readable medium, and is read by the CD-ROM device 440. Alternatively, the program is read by the communication modem via a computer network 426.

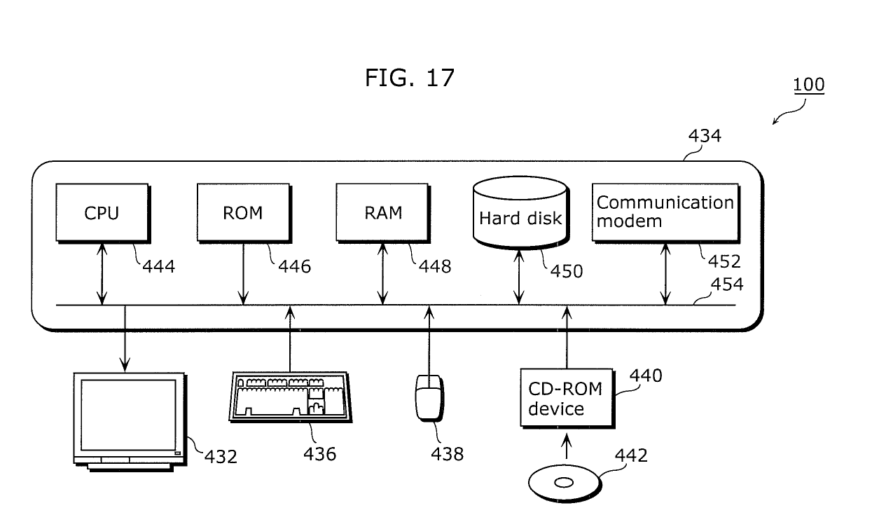

FIG. 17 is a block diagram showing a hardware configuration of the interaction force change prediction apparatus 100. The computer 434 has a central processing unit (CPU) 444, a read only memory (ROM) 446, a random access memory (RAM) 448, a hard disk 450, a communication modem 452, and a bus 454.

The CPU 444 executes a program read via the CD-ROM device 440 or the communication modem 452. The ROM 446 stores a program, data, and the like necessary for an operation performed by the computer 434. The RAM 448 stores a program executed by the CPU 444 and also stores intermediate data or the like generated during the program execution. The hard disk 450 stores a program, data, and the like. The communication modem 452 communicates with another computer via the computer network 426. The bus 454 interconnects the CPU 444, the ROM 446, the RAM 448, the hard disk 450, the communication modem 452, the display 432, the keyboard 436, the mouse 438, and the CD-ROM device 440.

In the following, correctness of the predicted value obtained by the interaction force change prediction apparatus 100 described in the present embodiment is verified.

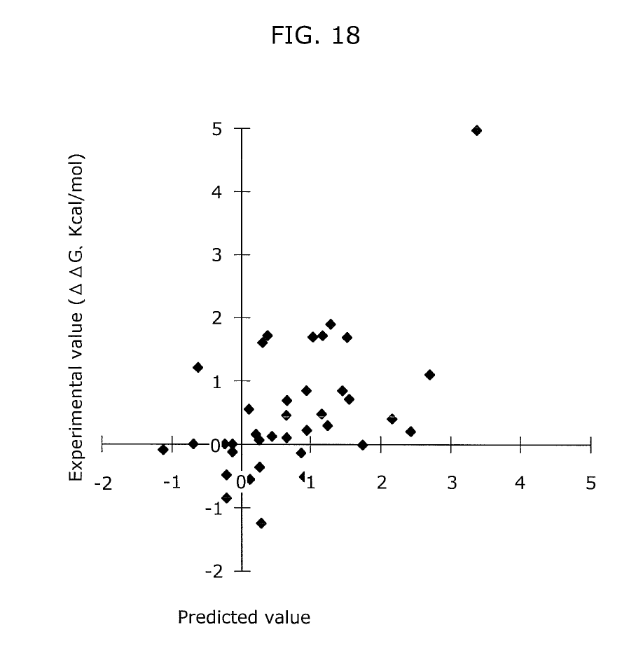

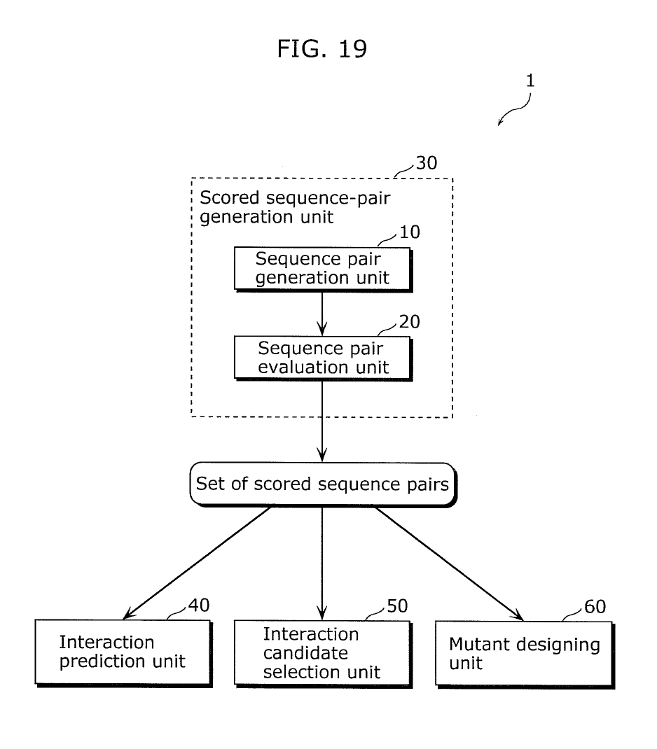

Suppose that, according to the method of predicting the interaction force change in the present embodiment, the three-residue combination table 151 is created using, as the complex conformation database 152, the 63 rigid-body complexes in the protein-protein docking benchmark data disclosed by Julian Mintseris et al., in “Protein-Protein Docking Benchmark 2.0: An Update”, PROTEINS, volume 60, Issue 2, 2005 (referred to as Non-Patent Reference 5). Moreover, by reference to the complex information and the amount of change in free energy of binding in a mutant obtained through a mutation applied at the binding site as disclosed by Non-Patent References 6 to 8 described below, PDB (Protein Data Bank) data whose PDB-IDs are 1B0G, 1MLC, 1VFB, and 2DQJ is used as the complex conformation information 101.
Non-Patent Reference 6: S. M. Lippow et al., “Computational design of antibody-affinity improvement beyond in vivo maturation”, Nature Biotechnology, volume 25, 2007
Non-Patent Reference 7: M. Shiroishi et al., “Structural Consequences of Mutations in Interfacial Tyr Residues of a Protein Antigen-Antibody Complex”, THE JOURNAL OF BIOLOGICAL CHEMISTRY, volume 282, number 9, 2007
Non-Patent Reference 8: I. Mandrika et al., “Improving the affinity of antigens for mutated antibodies by use of statistical molecular design”, Journal of Peptide Science, volume 14, 2008
   Furthermore, the input information disclosed in Non-Patent References 6 to 8 above is used as the mutation information 102 and, as a result, 39 predicted values 103 are obtained. FIG. 18 shows a graph obtained by plotting these predicted values 103 on the X axis and the amounts of change in free energy of binding disclosed in Non-Patent References 6 to 8 on the Y axis. That is, FIG. 18 is a diagram showing the correlation between predicted values and experimental values. Here, the positive and negative sings of 28 predicted values out of the 39 values agree with the signs of the experimental values, meaning that the degree of accuracy is about 72%. When the same experiment is executed using only the three-residue structure index, the degree of accuracy is about 62%. That is to say, by calculating the predicted value 103 using both the three-residue structure index and the amino-acid pair index, the degree of accuracy can be increased.

It should be noted that the interaction force changes, depending not only on the two amino acid residues at the bonding site but also on the amino acid residues positioned around these two. On account of this, the interaction force change can be accurately predicted using the three-residue combinations.

As described thus far in the present embodiment, even with less computational resources, the interaction force change prediction apparatus 100 having the configuration as explained above can predict a change in the interaction force between the proteins, by receiving the complex conformation information 101 and the mutation information 102 and then by reference to the three-residue combination table 151 showing 8,000 pairs of a three-residue character string and a score.

The interaction force change prediction apparatus 100 has been described in the present embodiment according to the present invention. Note that, however, the present invention is not limited to the present embodiment.

For example, the present embodiment has described a case where the amino acid residues of one pair are bound to form a complex of the proteins 501 and 502. However, the number of pairs to be bound between the proteins 501 and 502 may be more than one.

Also, in the present embodiment, the amino acid residues between which the Cα-Cα distance is equal to or shorter than 12*10⁻¹⁰ m are determined to be the pair at the binding site. However, a different criterion may be used. For example, when a distance between centroids of side chains of the amino acid residues is equal to or shorter than 6.5*10⁻¹⁰ m, these amino acid residues may be determined to be the pair at the binding site.

Moreover, in the present embodiment, the three-residue combinations shown in the column 631 of the three-residue combination table 151 are created by summarizing the three-residue combinations shown in the columns 621 to 624 in the three-residue combination data 130. However, the amino acid residues positioned in the N-terminal and C-terminal directions may be separately summarized. To be more specific, the summarization of the columns 621 and 623 may be separately performed from the summarization of the columns 622 and 624. This allows the process of predicting the interaction force change to be executed with a higher degree of accuracy. In this case, the number of rows in the three-residue combination table 151 doubles.

Furthermore, in the present embodiment, the subscores are calculated according to Equation 1 described above and then the sum total of the subscores is added as the score of the three-residue combination to the three-residue combination table 151. However, the frequency or probability of occurrence of the three-residue combination may be calculated as the score of the three-residue combination. Or, the mean value of the Cα-Cα distances shown in the column 625 in the three-residue combination data 130 may be calculated as the score of the three-residue combination.

Also, in the present embodiment, the interaction score calculation unit 213 calculates the interaction scores, namely, the pre-mutation interaction score 135 and the post-mutation interaction score 136, using the three-residue structure index and the amino-acid pair index. When the frequency at which the three residues in the combination form a binding site is higher and the three residues are positioned more closely, the three-residue structure index is larger. This represents a high degree of the binding force based on statistics of the existing complex conformation data. On the other hand, the amino-acid pair index represents a low degree of the binding force between the amino acid residues in terms of hydrogen bonding, electrostatic interaction, and hydrophobic interaction. Thus, when the interaction score is calculated according to Equation 2 described above, the three-residue structure index is multiplied by a negative coefficient and then the addition is performed. As shown by Equation 2, the ratio of the amino-acid pair index to the three-residue structure index is 2.85 to 2. The interaction score is an index which has properties of both an empirical structure index and a physicochemical index. However, the interaction score may be calculated using only the three-residue structure index. Also, the addition ratio of the three-residue structure index and the amino-acid pair index may be changed.

The embodiment disclosed thus far only describes an example in all respects and is not intended to limit the scope of the present invention. It is intended that the scope of the present invention not be limited by the described embodiment, but be defined by the claims set forth below. Meanings equivalent to the description of the claims and all modifications are intended for inclusion within the scope of the following claims.

Although only an exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The present invention is applicable to an interaction force change prediction apparatus or the like which predicts a change in an interaction force between proteins in vivo or in vitro. In particular, the present invention is useful in the overall field of protein study, including biochemistry, medical treatment, and pharmaceutical production.

What is claimed is:

1. An interaction force change prediction apparatus which predicts an interaction force change to be caused between two interacting proteins as a result of a mutation applied to at least one of the two interacting proteins, said interaction force change prediction apparatus comprising:
a pre-mutation combination data creation unit configured to create pre-mutation combination data including a plurality of three-residue combinations which are obtained by reference to complex conformation information indicating each position of atoms included in the two interacting proteins, the three-residue combinations each including (i) a pair of amino acid residues which are included in the two interacting proteins, respectively, and which are closely positioned at a predetermined distance from each other at a binding site of the two interacting proteins and (ii) one amino acid residue which is adjacent, in an amino acid sequence, to one of the amino acid residues in the pair, in an N-terminal or C-terminal direction;
a post-mutation combination data creation unit configured to create post-mutation combination data by reference to mutation information indicating a position of a pre-mutation amino acid residue of the protein to which the mutation is to be applied and a type of a resultant post-mutation amino acid residue, the post-mutation combination data including a post-mutation three-residue combination in which a type of the pre-mutation amino acid residue has been substituted with the type of the post-mutation amino acid residue for each of the three-residue combinations included in the pre-mutation combination data;
an interaction score calculation unit configured to calculate a pre-mutation interaction score and a post-mutation interaction score by reference to a three-residue combination table which shows a three-character string representing types of three arbitrary amino acid residues in association with a combination score indicating an interaction force produced when the three arbitrary amino acid residues represented by the three-character string form the three-residue combination at the binding site of the two interacting proteins, the pre-mutation interaction score indicating a mean value of the combination scores of the three-residue combinations included in the pre-mutation combination data and the post-mutation interaction score indicating a mean value of the combination scores of the post-mutation three-residue combinations included in the post-mutation combination data; and
a predicted-value calculation unit configured to calculate a difference between the pre-mutation interaction score and the post-mutation interaction score, as a predicted value for predicting the interaction force change to be caused between the two interacting proteins as a result of the mutation indicated by the mutation information.

2. The interaction force change prediction apparatus according to claim 1,
wherein the combination score shown in the three-residue combination table is statistically calculated using a plurality of sets of predetermined complex conformation information, the sets each indicating each position of atoms included in the two interacting proteins.

3. The interaction force change prediction apparatus according to claim 2,
wherein the combination score shown in the three-residue combination table is calculated using distance information on a distance between the amino acid residues in the pair included in the three-residue combination obtained from the sets of predetermined complex conformation information.

4. The interaction force change prediction apparatus according to claim 3,
wherein the combination score shown in the three-residue combination table is calculated as a value which increases with a decrease in the distance between the amino acid residues in the pair included in the three-residue combination obtained from the sets of predetermined complex conformation information.

5. The interaction force change prediction apparatus according to claim 2,
wherein the combination score shown in the three-residue combination table is calculated based on a frequency or probability of occurrence of the three-residue combination obtained from the sets of predetermined complex conformation information.

6. The interaction force change prediction apparatus according to claim 1,
wherein, by reference to a table showing a two-character string representing types of two amino acid residues in association with an amino-acid pair index which indicates, statistically or physicochemically, an interaction force between the two amino acid residues represented by the two-character string, said interaction score calculation unit is further configured (i) to add a mean value of the amino-acid pair indexes of the pairs of amino acid residues in the three-residue combinations included in the pre-mutation combination data to the pre-mutation interaction score, and (ii) to add a mean value of the amino-acid pair indexes of the pairs of amino acid residues in the post-mutation three-residue combinations included in the post-mutation combination data to the post-mutation interaction score.

7. An interaction force change prediction method used by a computer which predicts an interaction force change to be caused between two interacting proteins as a result of a mutation applied to at least one of the two interacting proteins, said interaction force change prediction method comprising:
creating pre-mutation combination data including a plurality of three-residue combinations which are obtained by reference to complex conformation information indicating each position of atoms included in the two interacting proteins, the three-residue combinations each including (i) a pair of amino acid residues which are included in the two interacting proteins, respectively, and which are closely positioned at a predetermined distance from each other at a binding site of the two interacting proteins and (ii) one amino acid residue which is adjacent, in an amino acid sequence, to one of the amino acid residues in the pair, in an N-terminal or C-terminal direction;
creating post-mutation combination data by reference to mutation information indicating a position of a pre-mutation amino acid residue of the protein to which the mutation is to be applied and a type of a resultant post-mutation amino acid residue, the post-mutation combination data including a post-mutation three-residue combination in which a type of the pre-mutation amino acid residue has been substituted with the type of the post-mutation amino acid residue for each of the three-residue combinations included in the pre-mutation combination data;
calculating a pre-mutation interaction score and a post-mutation interaction score by reference to a three-residue combination table which shows a three-character string representing types of three arbitrary amino acid residues in association with a combination score indicating an interaction force produced when the three arbitrary amino acid residues represented by the three-character string form the three-residue combination at the binding site of the two interacting proteins, the pre-mutation interaction score indicating a mean value of the combination scores of the three-residue combinations included in the pre-mutation combination data and the post-mutation interaction score indicating a mean value of the combination scores of the post-mutation three-residue combinations included in the post-mutation combination data; and
calculating a difference between the pre-mutation interaction score and the post-mutation interaction score, as a predicted value used for predicting the interaction force change to be caused between the two interacting proteins as a result of the mutation indicated by the mutation information.

8. A computer program recorded on a non-transitory computer-readable recording medium for use in a computer, causing the computer to execute the interaction force change prediction method according to claim 7.
